(19) United States
(12) Patent Application Publication
(10) Pub. No.: US 2008/0308577 A1
(43) Pub. Date: Dec. 18, 2008

(54) E. A. S. killer (extension arm spray tool)

(76) Inventor: Weixiong Huo, Las Vegas, NV (US)

Correspondence Address: Weixiong Huo, 7497 Coral River Dr, Las Vegas, NV, 89131, US

(21) Appl. No.: 11/818,147

(22) Filed: Jun. 14, 2007

(51) Int. Cl. B67D 5/00

(52) U.S. Cl. 222/174

(57) ABSTRACT

The current aerosol spray can is held by hand and is used in reachable places. This invention is for when people find spiders or other insects on unreachable places like ceiling or eaves of a building.

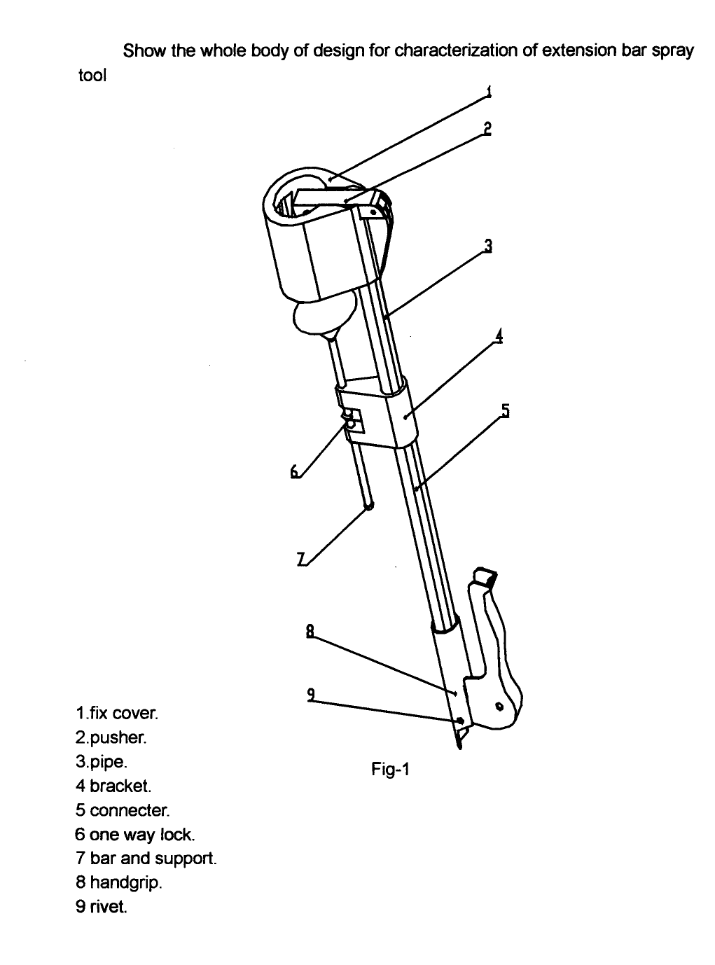

Any changes may be made in the foregoing disclosure without departing from the scope of the invention herein involved, it's intended that all matter contained in the above description and drawings be construed in an illustrative and not limiting in a sense.

### CROSS-REFERENCE TO RELATED APPLICATION

not applicable.

### FEDERALLY SPONSORED RESEARCH

Not applicable.

### SEQUENCE LISTING OR PROGRAM

Not applicable.

### BACKGROUND OF THE INVENTION

1. Field of Invention

This invention relates to aerosol spray can for killing insects and painting in out-of-reach places.

2. Background of the Invention

Allows people to remain or stand on the ground with the E.A.S. killer (extension arm spray tool) to get rid of unwanted spiders,centipedes,wasps,hornets and other insects from inside and outside of buildings out-of-reach places. It's more convenient for the housekeeper and keeps them from having to use a ladder or stand on a chair. That is the purpose of this invention.

Also,this invention can be used for other purposes using aerosol spray can.

### DRAWINGS—REFERENCE NUMERALS

1. Fix cover; To cover and fix a head of aerosol spray can.

2. Pusher; To push a fixed keystroke on aerosol spray can.

3. Pipe; for extension.

4. Bracket; to hold and support item 7 bar. And holds one way spring lock item 6.

5. Connector; This long piece of thin stock is to connect and allow movement inside pipe from item 8 handgrip to item 2 pusher.

6. One way lock; To lock item 7 bar and support.

7. Bar and support; to support bottom of aerosol spray can.

8. Handgrip; connects to the connecter and pusher.

9. Rivet; rivet shaft.

I claim:

1. The purpose of this design is for use of aerosol spray can to spray out-of-reach places.

2. Design of configuration.

3. product of invention.
